(19) United States
(12) Patent Application Publication
(10) Pub. No.: US 2024/0188605 A1
(43) Pub. Date: Jun. 13, 2024

(54) SOY MILLING AND FRACTIONATION

(71) Applicant: Benson Hill, Inc., St. Louis, MO (US)

(72) Inventors: Eric LII, St. Louis, MO (US); Jason F. LOMBARDI, St. Charles, MO (US)

(73) Assignee: Benson Hill, Inc., St. Louis, MO (US)

(21) Appl. No.: 18/530,908

(22) Filed: Dec. 6, 2023

Related U.S. Application Data
(60) Provisional application No. 63/430,980, filed on Dec. 7, 2022.

(51) Int. Cl. A23L 11/00; A23J 3/16

(52) U.S. Cl. CPC A23L 11/03; A23J 3/16

(57) ABSTRACT

The present disclosure relates generally to methods of processing soy, and more specifically to methods of processing soy comprising air classification.

### CROSS-REFERENCE TO RELATED APPLICATIONS

This application claims priority to U.S. Provisional Patent Application No. 63/430,980 filed Dec. 7, 2022, which is incorporated herein by reference in its entirety.

### FIELD

The present disclosure relates generally to methods of processing soy, and more specifically to methods of processing soy using air classification. Such methods may also be adapted to process other grains.

### BACKGROUND

Soybeans represent an attractive renewable source of protein for use in foodstuffs. However, the protein content of unprocessed soybeans is too low for many product applications. High protein content soy ingredients are desirable for a variety of food products and applications. High protein soy ingredients are desirable for their nutritional properties, as well as the functional properties derived from their protein content. These functional properties are the intrinsic physicochemical characteristics which affect the behavior of a food ingredient in food systems during processing, manufacturing, storage and preparation.

Wet fractionation is commonly used to prepare protein-enriched compositions from soybeans. This type of process typically involves immersing soybeans in aqueous solutions containing acids, bases, and/or other chemical processing agents. As a result, protein-enriched soy compositions prepared via a wet process contain chemical residues from the processing solution. Further, the use of acids, bases, and/or chemical processing agents in the wet process can result in loss of native functionality in the soy proteins in the processed soy composition.

There is a need in the art not only for soy compositions having high protein content and desirable functional properties, but also for streamlined and inexpensive methods of producing these high-protein soy compositions.

### BRIEF SUMMARY

The present disclosure provides, among other things, a soy product comprising from about 60 wt. % to about 70 wt. % protein on a dry weight basis; less than 35 wt. % carbohydrates. In some embodiments, provided is a soy product with a protein content of over 65 wt. % on a dry weight basis, prepared according to a process that does not use any ethanol, acid, or any wet processing and which reduces water and energy usage.

The present disclosure provides a soy product comprising from about 60 wt. % to about 70 wt. % protein on a dry weight basis; and less than 35 wt. % carbohydrates, wherein the soy product comprises one or more particles each having a particle size between about 20 microns and about 50 microns at the 90th percentile.

The present disclosure provides a soy product produced by a process, the process comprising milling soy white flakes to provide a milled soy powder having a median 90th percentile particle size of about 80 microns to about 150 microns; and fractionating the milled soy powder to a soy product having greater than 70 wt. % protein on a dry weight basis, wherein the soy product having a mean 90th percentile particle size of about 20 microns to about 50 microns in various aspects.

The present disclosure provides a method of making a soy product, the method comprising milling soy flakes to produce a milled soy product; and fractionating the milled soy powder to produce the soy product in various aspects.

In one aspect, provided is a method of processing soy, comprising providing high protein soy white flakes, milling the high protein soy white flakes to provide milled high protein soy white flakes, and processing the milled high protein soy white flakes using air classification to directly provide a soy product comprising at least about 60 wt. % protein on a dry weight basis. In some embodiments, providing the high protein soy white flakes comprises providing high protein soybeans and processing the high protein soybeans to provide high protein soy white flakes.

In one aspect, provided is a soy product prepared according to any of the foregoing methods.

### DETAILED DESCRIPTION

The following description sets forth exemplary methods, parameters and the like. It should be recognized, however, that such description is not intended as a limitation on the scope of the present disclosure but is instead provided as a description of exemplary embodiments.

A milled soy product with high protein content can be produced, for example, by a process comprising milling and particle size fractionation. Dried soy flakes can, for example, be ground and particle fractionated to produce a milled soy product with, for example, more than 60 wt. % protein on a dry weight basis.

Specifically, the dried soy flakes can be ground, by a grinder or milling process, and then fractionated out, such as by air classification or sieving. The grinding and subsequent fractionation can allow for carbohydrate material and other impurities to be removed and increase the weight percentage of protein in the product.

A soy product can be made from soy flake precursor material typically in a range of PDI (protein dispersibility index) from about 20 to about 90, such as a PDI 50, 70, or 90. PDI is a measurement of the degree the ground and/or defatted soy precursor material may be dispersed in water without particle settling. PDI can be determined, for example, by measuring the percentage of nitrogen in a sample that may be dispersed in water under standardized conditions. Several grades of commonly available soy flakes typically include PDI 90, 70, 50, and 20. Generally, the lower the PDI, the more the soy flake has been “toasted.” This results in higher PDI flakes having a white color.

The soy flakes can, for example, have a particle size of about 200 to about 1500 microns (e.g., about 500 to about 1000 microns). The soy flake precursor material is the material used for creation of the soy product. The soy flake precursor material can include, for example, 90 PDI, 70 PDI, 50 PDI, or 20 PDI flakes that can be ground and fractionated.

The soy flakes can be defatted. The fat may be removed from the soy flakes in a number of different methods. For example, the soy flakes can be defatted by using an organic solvent, such as hexane or by continuous pressing by means of expellers (also known as screw presses), a widely applied process for the mechanical extraction of oil from oilseeds. Typically, the soy flakes can originate from dehulled seeds that are flattened into flakes, followed by the defatting with an organic solvent. The product of this defatting process can be commonly referred to as “white flakes.” In general, defatted soy flakes have about 1% or less fat by mass.

Specifically, in an example defatting process, the solvent can be extracted by passing the white flake through a chamber containing hot solvent vapor. Residual hexane can then, for example, be removed from soybean white flakes by passage through a chamber containing hexane vapor at a temperature less than about 75° C. Under such conditions, the bulk of the residual hexane vapor can volatize from the flakes and can be removed, for example, by a process such as vacuum extraction. This process can be referred to as “flash desolventized oilseed white flake.”

Alternatively, the soy flake product can be, for example, desolventized through a method referred to as “toasting.” In a toasting process, the hexane extracted flakes can be passed through a chamber containing steam at a temperature of at least about 105° C. The can, for example, cause the solvent in the flakes to volatize and be carried away with the steam. After desolventization, the flakes can be defatted. The chemical and physical properties of the soy precursor material can vary based on the previous processing and thermal history of the soy flakes or flour.

The precursor material can be ground to provide a coarsely ground soy material with a particle size larger than a conventional soy flour. For example, the precursor material can be coarsely milled through grinding or other milling mechanisms. The precursor material can be ground in various type of mills, including, for example, a disc mill, a knife mill, a hammer mill, or an air classifier mill, to achieve the desired particle size by controlling speed and screen in place.

The milling step can typically produce milled soy products having a median particle size at the 90th percentile of about 80 microns to about 150 microns (e.g., less than 80 microns, less than 60 microns, less than 40 microns, less than 30 microns or less than 25 microns; about 0.05 to about 90 microns, about 1 to about 50 microns, about 5 to about 30 microns, about 0.1 to about 10 microns or about 0.05 to about 5 microns). In some aspects, the milled soy product can contain a plurality of particles, each particle having a largest dimension of less than 100 microns (e.g., less than 80 microns, or less than 60 microns, less than 40 microns, less than 30 microns or less than 25 microns; about 0.05 to about 90 microns, about 1 to about 50 microns, about 5 to about 30 microns, about 0.1 to about 10 microns or about 0.05 to about 5 microns). The particle size can be larger, for example, than a traditional soy flour, so that the milled soy product can be fractionated, and carbohydrates, hemi-cellulosic materials, or other impurities can be removed.

After coarsely milling the soy white flake precursor material, the milled material can be fractionated. Fractionation can be done, for example, by hand with a stack of sieves in series. For example, the stack can include, but is not limited to, sieves with 60 mesh size (pore per inch), 100 mesh size, 140 mesh size, 200 mesh size, and 325 mesh size. The milled material can be sieved through each sieve mesh size in series, ending with the 325 mesh size. The fractions of the material can be further sieved or used elsewhere.

Alternatively, the milled soy product can be fractionated with a machine such as an air classification system or similar. In this case, the milled soy product can be fractionated at speeds ranging from about 1000 rpm to about 2000 rpm (e.g., 1500 rpm). Alternative methods of fractionation, such as larger containers rotated at a lower rpm, could be used to separate the material.

The resulting milled and fractionated soy product has greater than 65 wt. % protein content on a dry weight basis. Such a protein content cannot be achieved traditionally without water and ethanol use. The enriched protein flour could further be used as soy protein concentrate or as a feedstock for an soy protein isolate manufacturer to reduce the water and energy usage.

In some variations of the foregoing, the soy flakes, white flakes, or soy white flakes are prepared from high protein soybeans.

In some variations of the foregoing, high protein soybeans have a protein content of at least about 40%, at least about 41%, at least about 42%, at least about 43%, at least about 44%, at least about 45%, at least about 46%, at least about 47%, at least about 48%, at least about 49%, at least about 50%, at least about 51%, or at least about 52% soy protein on a dry weight basis. In certain variations, high protein soybeans have a protein content of at least about 42% soy protein on a dry weight basis. In some variations, high protein soybeans have a protein content of at least about 45% soy protein on a dry weight basis. In other variations, high protein soybeans have a protein content of at least about 48% soy protein on a dry weight basis.

In some variations of the foregoing, at least a portion of the soybeans used has a protein content of at least about 40%, at least about 41%, at least about 42%, at least about 43%, at least about 44%, at least about 45%, at least about 46%, at least about 47%, at least about 48%, at least about 49%, at least about 50%, at least about 51%, or at least about 52% soy protein on a dry weight basis. In certain variations, at least a portion of the soybeans used has a protein content of at least about 42% soy protein on a dry weight basis. In some variations, at least a portion of the soybeans used has a protein content of at least about 45% soy protein on a dry weight basis. In other variations, at least a portion of the soybeans used has a protein content of at least about 48% soy protein on a dry weight basis.

In other variations of the foregoing embodiments, the soybeans used have an average protein content comprising at least about 40%, at least about 41%, at least about 42%, at least about 43%, at least about 44%, at least about 45%, at least about 46%, at least about 47%, at least about 48%, at least about 49%, at least about 50%, at least about 51%, or at least about 52% soy protein on a dry weight basis. In certain variations, the soybeans used have an average protein content of at least about 42% soy protein on a dry weight basis. In some variations, the soybeans used have an average protein content of at least about 45% soy protein on a dry weight basis. In other variations, the soybeans used have an average protein content of at least about 48% soy protein on a dry weight basis.

In yet other variations of the foregoing embodiments, the majority of the soybeans used has a protein content of at least about 40%, at least about 41%, at least about 42%, at least about 43%, at least about 44%, at least about 45%, at least about 46%, at least about 47%, at least about 48%, at least about 49%, at least about 50%, at least about 51%, or at least about 52% soy protein on a dry weight basis. In certain variations, the majority of the soybeans used has a protein content of at least about 42% soy protein on a dry weight basis. In some variations, the majority of the soybeans used has a protein content of at least about 45% soy protein on a dry weight basis. In other variations, the majority of the soybeans used has a protein content of at least about 48% soy protein on a dry weight basis.

In some embodiments, the soybeans having a high protein content as used in the methods provided are distinguished from commodity soybeans. Commodity soybeans may have a protein content of less than 40%, or between about 35% and about 40%, on a dry weight basis. The commodity soybeans may also have one or more additional properties: (i) an oil content of between about 15% and about 25% on a dry weight basis; (ii) a moisture content of between about 10% and 15%; (iii) a seed weight of between 10 g and 20 g per 100 seeds; (iv) a lysine content of between 5% and 10%, expressed as a percentage of the 18 primary amino acids; and (v) an essential amino acid content of between 10% and 20%, expressed as a percentage of the 18 primary amino acids. Similarly, the protein-enriched soy compositions, protein-enriched texturized soy compositions, and protein-enriched re-functionalized soy compositions obtained from the soybeans having a high protein content described herein are distinguished from soy protein products obtained from commodity soybeans, such as soy flours, soy white flakes, soy protein concentrates, and soy protein isolates.

The percent composition of a given component in a soybean or sample of soybeans may be described on an “as-is” basis or on a “dry-weight” basis. The percent composition of a given component may be converted between an “as-is” basis and a “dry-weight” basis using the following equation:

(protein content, “dry-weight” basis, %)=(protein content, “as-is” basis, %)/((100%)−(moisture content, %)) Eq. 1

The word “protein” in the above equation may be interchanged with any other soybean component for which conversion between an “as-is” and a “dry-weight” basis is needed, including, e.g., oil. The moisture content of a soybean or soybean product may be determined using any suitable methods or techniques known in in the art. See e.g., Eys, J. E. Van. Manual of Quality Analyses For Soybean Products in The Feed Industry, 2^{nd} ed. U.S. Soybean Export Council.

### EXAMPLES

The presently disclosed subject matter will be better understood by reference to the following Examples, which are provided as exemplary of the invention, and not by way of limitation.

### Example 1: Laboratory Grinding and Fractionating

Two types of precursor materials are used for comparison: mesh 100 (150 um) and mesh 200 (80 um). High protein soy flour is obtained with protein dispersibility index (PDI) of 70.

TABLE 1
Sample Descriptions

| Example | | | Protein |
|---|---|---|---|
| No. | Type | Precursor Material Description | (%, DB) |
| 1 | Ground | Soy flour 100 Mesh 70PDI | 60.3% |
| 2 | Ground | Soy Flour 100 Mesh 90PDI | 60.0% |
| 3 | Ground- | Classified Soy flour 100 Mesh | TBD |
| | classified | 70PDI with 35 um screen | |
| 4 | Ground- | Classified Soy flour 100 Mesh | TBD |
| | classified | 70PDI with 40 um screen | |
| 5 | Ground- | Classified Soy flour 100 Mesh | TBD |
| | classified | 70PDI with 45 um screen | |
| 6 | Ground- | Classified Soy flour 200 Mesh | TBD |
| | classified | 70PDI with 35 um screen | |
| 7 | Ground- | Classified Soy flour 200 Mesh | TBD |
| | classified | 70PDI with 40 um screen | |
| 8 | Ground- | Classified Soy flour 200 Mesh | TBD |
| | classified | 70PDI with 45 um screen | |

### Example 2: Further Processing of Low-Fiber Soy Flour

The flour of example 1 is further processed to provide a soy protein isolate. The flour subjected to air classification in example 1 contains 66% less insoluble fiber than unprocessed flour. This reduction in insoluble fiber content achieved via air classification reduces the amount of energy and water that must be used in the extraction and wash cycle in order to provide the soy protein isolate.

### Example 3: Functional Testing of High Protein Soy Flour

The functional properties of the air-classified soy flour of example 1 are tested and compared against the properties of a corresponding soy product prepared from commodity soybeans. Functional properties including protein dispersibility index, water holding capacity, oil holding capacity, oil binding, emulsification, foam capacity, foam stability, gelation, minimum gelling concentration, gelling strength, bulk density, texture, whipping capacity, and viscosity are tested.

The high protein (>65 wt. % protein on a dry weight basis) flour of example 1 exhibits comparable functionality to current market soy protein concentrate prepared using commodity soybeans.

### Example 4: Analysis of Examples 1-3

The soy products produced in examples 1-3 are further analyzed to assess their protein and carbohydrate content, as well as the composition of other components. The viscosity of the products are also measured.

What is claimed is:

1. A method of processing soy, comprising:
providing high protein soy white flakes;
milling the high protein soy white flakes to provide milled high protein soy white flakes; and
processing the milled high protein soy white flakes using air classification to directly provide a soy product comprising at least about 60 wt. % protein on a dry weight basis.

2. The method of claim 1, wherein the high protein soy white flakes comprise at least about 55 wt. % protein on a dry weight basis.

3. The method of claim 1, wherein the soy product comprises between about 60 wt. % and about 70 wt. % protein on a dry weight basis.

4. The method of claim 1, wherein providing the high protein soy white flakes comprises providing high protein soybeans and processing the high protein soybeans to provide high protein soy white flakes.

5. The method of claim 4, wherein the high protein soybeans comprise at least about 48 wt. % protein on a dry weight basis.

6. The method of claim 1, wherein the soy product comprises less than 35 wt. % carbohydrates.

7. The method of claim 1, wherein processing the milled high protein soy white flakes using air classification does not comprise the use of a solvent wash.

8. A method of making a soy product, the method comprising:
coarsely milling soy flakes to produce a milled soy powder; and
fractionating the milled soy powder to produce the soy product comprising:
from about 60.0 wt. % to about 70.0 wt. % protein on a dry weight basis;
less than 35.0 wt. % carbohydrates; and
an increased amount of protein in a dispersible fraction of the soy product, compared to the amount of protein in a dispersible fraction of a defatted soy flake having the same starting protein dispersibility index.

9. A soy product prepared according to the method of claim 1.
